(19) United States
(12) Patent Application Publication
(10) Pub. No.: US 2012/0042914 A1
(43) Pub. Date: Feb. 23, 2012

(54) Electric Household Washing Appliance

(75) Inventors: Monica Celotto, Motta di Livenza (TV) (IT); Andrea Zattin, Solesino (PD) (IT); Biagio Salvati, I-Udine (IT)

(73) Assignee: ELECTROLUX HOME PRODUCTS CORPORATION N.V., Brussel (BE)

(21) Appl. No.: 13/148,604

(22) PCT Filed: Jan. 13, 2010
(86) PCT No.: PCT/EP10/00136

§ 371 Date: Oct. 5, 2011

(30) Foreign Application Priority Data
Feb. 23, 2009 (EP) 09002510.7

(51) Int. Cl. B08B 7/04; B08B 3/00

(52) U.S. Cl. 134/58 R

(57) ABSTRACT

An electric household washing appliance has a wash tub (8) for the articles to be washed; a UV source (15; 31) for processing the water drained from the wash tub (8) along a hydraulic recirculating circuit (10); and a casing (2) having an opening (19; 23; 29) formed through a wall (3; 4) of the casing (2) and by which to insert and remove the UV source (15; 31) into and from the casing (2).

The present invention relates to an electric household washing appliance, in particular a laundry washing machine or dishwasher.

The electric household appliance industry manufactures appliances comprising a casing; a wash tub for housing the articles to be washed, and mounted inside the casing; and a hydraulic feed circuit for feeding mains water into the wash tub and draining water from the wash tub into the drains.

As disclosed in documents DE-4342049-A and U.S. Pat. No. 6,253,584-A, the appliance also comprises a hydraulic recirculating circuit which is normally operated instead of the hydraulic feed circuit; and a processing unit for processing the water drained from the wash tub along the hydraulic recirculating circuit, and which comprises a UV lamp mounted inside the casing to disinfect the water drained from the wash tub.

The UV lamps being mounted in hard-to-reach parts of the casing, known electric household washing appliances of the above type have various drawbacks, mainly due to replacement of the lamps, in the event of a malfunction, and disposal of the lamps, when the appliance is scrapped, having to be carried out by a service engineer, and being a painstaking, relatively time-consuming job.

It is an object of the present invention to provide an electric household washing appliance designed to eliminate the above drawbacks, and which is cheap and easy to produce.

According to the present invention, there is provided an electric household washing appliance as claimed in the accompanying Claims.

A non-limiting embodiment of the present invention will be described by way of example with reference to the accompanying drawings, in which:

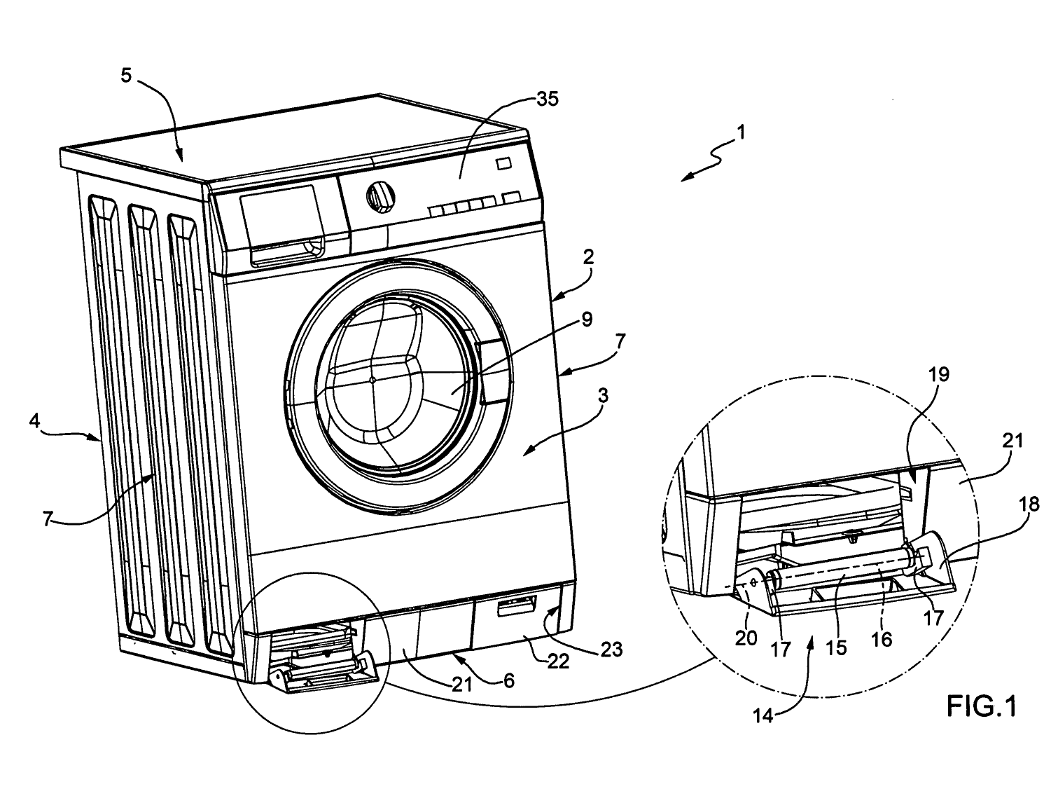

FIG. 1 shows a schematic view in perspective and enlarged detail of a preferred embodiment of the electric household washing appliance according to the present invention;

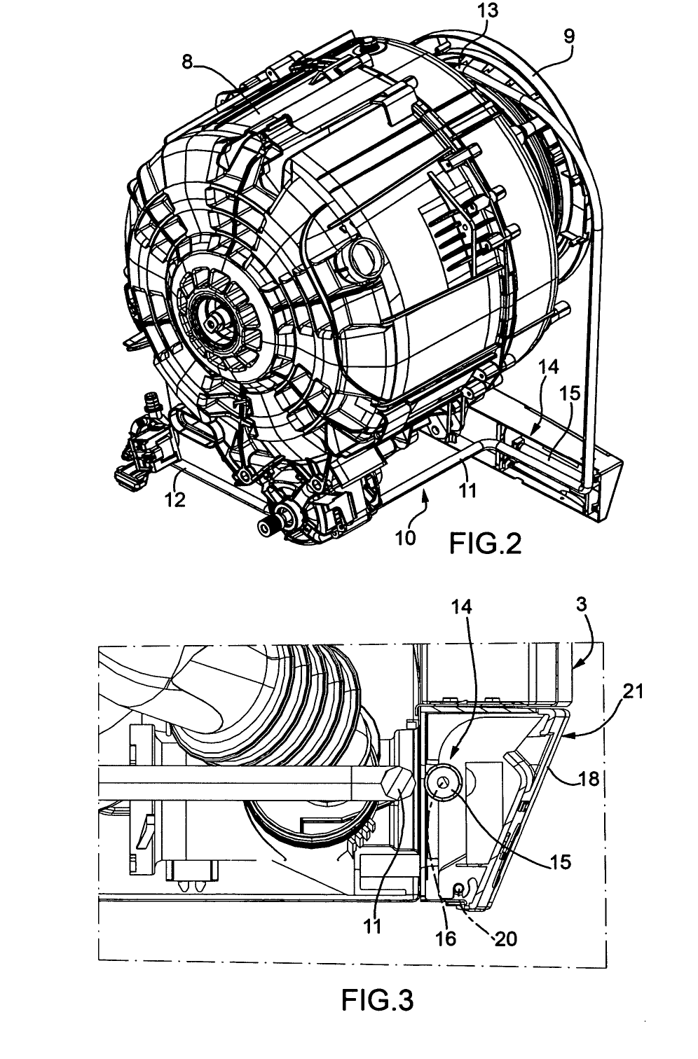

FIG. 2 shows a schematic view in perspective of a first detail of the FIG. 1 appliance;

FIG. 3 shows a schematic lateral view of a second detail of the FIG. 1 appliance;

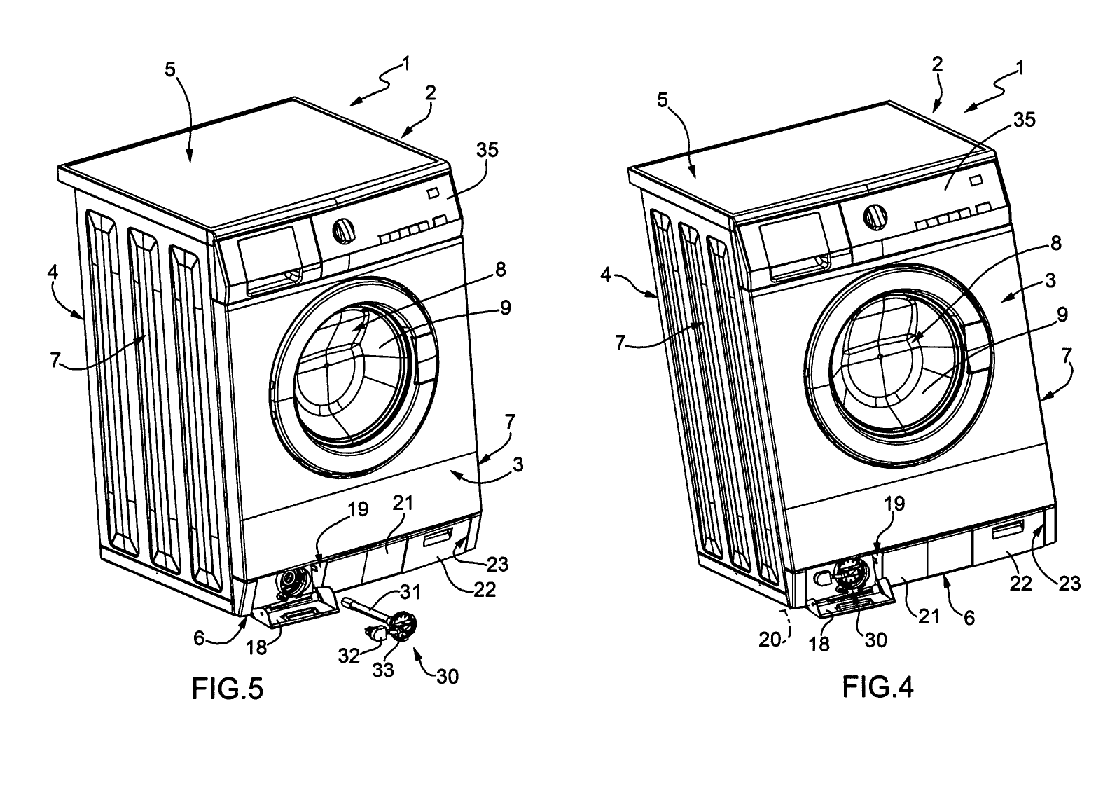

FIG. 4 shows a schematic view in perspective of a variation of the FIG. 1 appliance;

FIG. 5 shows a partly exploded view in perspective of a variation of the FIG. 4 appliance;

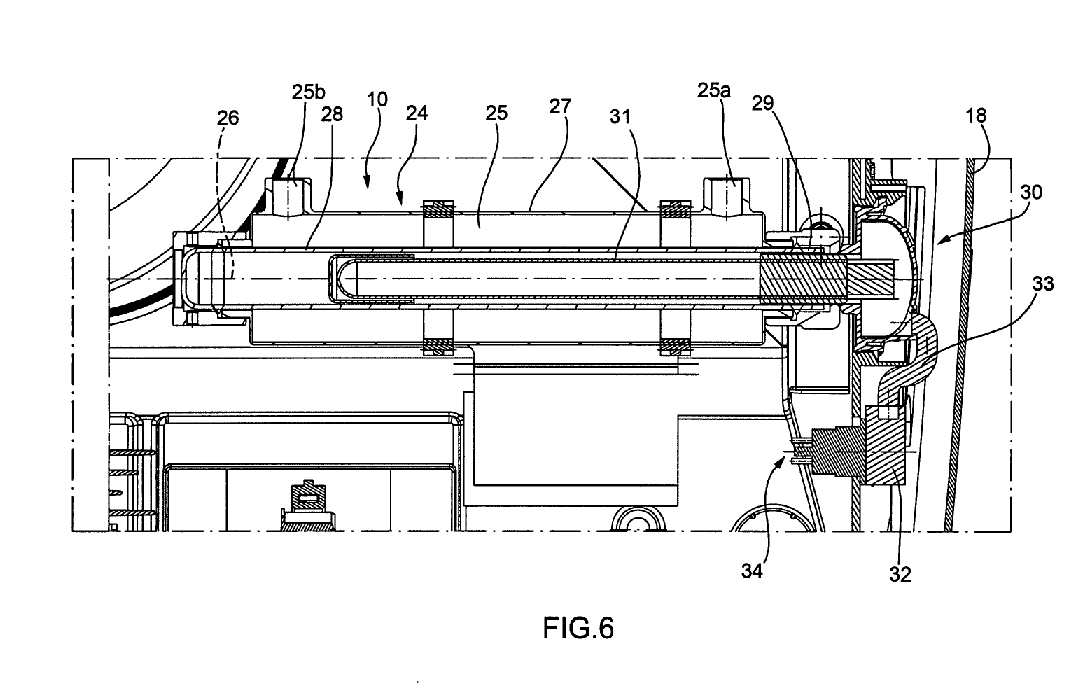

FIG. 6 shows a partly sectioned, schematic plan view, with parts removed for clarity, of a detail in FIGS. 4 and 5.

With reference to FIGS. 1, 2, and 3, number 1 indicates as a whole an electric household washing appliance defined, in the example shown, by a laundry washing machine comprising a substantially parallelepiped-shaped casing 2 bounded by a front wall 3 and a rear wall 4 substantially parallel to each other, a top wall 5 and a bottom wall 6 substantially parallel to each other and perpendicular to walls 3 and 4, and two lateral walls 7 substantially parallel to each other and perpendicular to walls 3, 4, 5 and 6.

Washing machine 1 comprises a substantially cylindrical wash tub 8 housed inside casing 2 and accessible from the outside through a loading door 9 formed through front wall 3; and a hydraulic feed circuit (not shown) for feeding mains water into wash tub 8 and draining the water from wash tub 8 into the drains.

Washing machine 1 also comprises a hydraulic recirculating circuit 10, which is normally operated instead of the hydraulic feed circuit (not shown), and which in turn comprises a pipe 11 extending between an inlet 12, located at the bottom of wash tub 8 to receive the drain water from wash tub 8, and an outlet 13 fitted to the top of wash tub 8 to feed the water back into wash tub 8.

The water drained from wash tub 8 along pipe 11 is disinfected by a processing unit 14 comprising an elongated UV lamp 15 having a longitudinal axis 16 and fitted removably to two supporting members 17, which are designed to receive and retain the ends of lamp 15, electrically power lamp 15, and are fitted inside a supporting hatch 18 closing an opening 19 in front wall 3 of casing 2.

Hatch 18 is fitted to casing 2 to rotate, with respect to casing 2 and about a hinge axis 20 substantially parallel to axis 16, between a closed position (FIG. 3), in which hatch 18 is coplanar with front wall 3 to close opening 19, and lamp 15 is positioned facing an intermediate portion of pipe 11, and an open position (FIG. 1), in which lamp 15 is accessible from outside casing 2 and can be changed quickly and easily by the user or a service engineer.

In connection with the above, it should be pointed out that, in the example shown:

opening 19 is formed through a bottom portion 21, made of plastic, of front wall 3;

the intermediate portion of pipe 11 facing lamp 15 is made of material transparent to UV radiation; and

hatch 18 is symmetrical with a hatch 22 closing an opening 23 formed through portion 21 to receive a filter (not shown) of washing machine 1.

The FIG. 4-6 variation differs from the FIG. 1-3 embodiment by pipe 11 being replaced by a pipe 24 comprising an annular intermediate portion 25, which has a substantially horizontal longitudinal axis 26 perpendicular to front wall 3, is defined between an outer sleeve 27 and a cup-shaped inner body 28 fitted inside sleeve 27 and coaxial with axis 26, and comprises an outlet 25a and an inlet 25b (it is evident that the aperture 25a , can be used as an inlet whereas the aperture 25b can be used as an outlet depending on the direction of the stream of the water flowing along the recirculating circuit 10).

Body 28 is made at least partially of material transparent to UV radiation, is fitted in fluidtight manner to sleeve 27, and has an open end 29 projecting axially outside sleeve 27 and facing hatch 18.

Pipe 24 comprises an inlet portion (not shown) connected hydraulically to the bottom of wash tub 8 and to portion 25 for example via inlet 25b; and an outlet portion (not shown) connected hydraulically to the top of wash tub 8 and to portion 25 for example via outlet 25a.

The water fed along pipe 24 is disinfected by a processing unit 30 comprising an elongated UV lamp 31, which slides inside body 28 and is powered electrically by an electric connector 32, which is connected to lamp 31 by an electric cable 33 and slides inside a socket 34 fitted inside casing 2.

Unit 30 is therefore connected removably to body 28 and socket 34 through open and 29, and can be changed quickly and easily by the user or a service engineer once hatch 18 is opened.

In the embodiment described by way of example at FIG. 6, the body 28 forms a wall of the annular intermediate portion 25 so that such wall, at least partially in UV transparent material for allowing the UV lamp to radiate the water, separates the UV lamp from the water flowing along the sleeve 27.

In variations not shown:

hatch 18 and opening 19 are formed in rear wall 4 of casing 2;

hatch 18 and opening 19 are formed in a top control panel 35 or in the upper wall 5 (i.e. in the worktop) of washing machine 1;

hatch 18 and opening 19 are eliminated, and processing unit 14, 30 is housed inside opening 23 and accessible from the outside of casing 2 by means of hatch 22;

hatch 18 is replaced by a cover fitted preferably, though not necessarily, to one end of lamp 15, 31 and fitted removably to casing 2 or defined directly by the same end of lamp 15, 31, for example the hatch 18 shown in FIGS. 4, 5 and 6 can be eliminated and the UV lamp 31 is simply removable and insertable through the body 28 by means of the cover associated to and end of the UV lamp 31 and clearly depicted in FIGS. 4, 5 and particularly in FIG. 6;

electric cable 33 is eliminated and lamp 31 is powered electrically in a contactless manner (for example via electromagnetic induction);

hatch 18 is made at least partly of material transparent to visible light but not to UV radiation to allow control of the processing unit 14 and/or of the presence of lamp 15, 31;

lamp 15, 31 is replaced by a UV Light Emitting Diode.

1. An electric household washing appliance, the electric household appliance comprising a wash tub for the articles to be washed; a hydraulic recirculating circuit for feeding water through the wash tub; a processing unit for processing the water drained from the wash tub along the hydraulic recirculating circuit, the processing unit comprising at least one UV source; and a casing housing the wash tub and at least part of the hydraulic recirculating circuit; herein the casing comprises an opening formed through a wall of the casing which allows the insertion and removal of the UV source into and from the casing.

2. An electric household washing appliance as claimed in claim 1, further comprising a covering closing the opening.

3. An electric household washing appliance as claimed in claim 2, wherein the covering comprise a hatch fitted to the casing to rotate between an opening position and a closed position opening and closing the opening respectively.

4. An electric household washing appliance as claimed in claim 2, wherein the covering comprises a cover fitted removably to the casing.

5. An electric household washing appliance as claimed in claim 2, wherein the covering comprises a cover fitted to one end of the UV source.

6. An electric household washing appliance as claimed in claim 1, further comprising an electric connector for electrically powering the UV source; and an electric cable connecting the electric connector to the UV source.

7. An electric household washing appliance as claimed in claim 6, wherein the opening also comprises a socket to which said electric connector is connected.

8. An electric household washing appliance as claimed claim 2, wherein the covering comprises a hatch that has at least one fastening member for fastening the UV source; the fastening member being designed to power the UV source electrically.

9. An electric household washing appliance as claimed in claim 1, wherein the opening also permits insertion and removal of a filter into and from the casing.

10. An electric household washing appliance as claimed in claim 1, wherein the hydraulic recirculating circuit comprises a feed pipe for water drained from the wash tub; the UV source being mounted outside the feed pipe and positioned facing the feed pipe.

11. An electric household washing appliance as claimed in claim 1, wherein the hydraulic recirculating circuit comprises a feed pipe for water drained from the wash tub; and a cup-shaped body at least partially made of material transparent to UV and which extends inside the feed pipe to receive the UV source.

12. An electric household washing appliance as claimed in claim 1, wherein the casing comprises a rear wall, two lateral walls, an upper wall, and a front wall which in turn comprises a top control panel and a base made of plastic material; the opening being formed through the base.

13. An electric household washing appliance as claimed in claim 2, wherein the covering closing the opening is made at least partly of material transparent to visible light but not to UV radiation to allow control of the processing unit and/or of the presence of a lamp.

14. An electric household washing appliance as claimed in claim 1, wherein the UV source comprises a UV Light Emitting Diode.

15. An electric household washing appliance as claimed in claim 1, wherein the UV source is powered electrically in a contactless manner.
